(19) United States
(12) Patent Application Publication
(10) Pub. No.: US 2018/0182124 A1
(43) Pub. Date: Jun. 28, 2018

(54) ESTIMATION SYSTEM, ESTIMATION METHOD, AND ESTIMATION PROGRAM

(71) Applicant: FOVE, INC., San Mateo, CA (US)

(72) Inventor: Pavel Savkin, Tokyo (JP)

(21) Appl. No.: 15/855,126

(22) Filed: Dec. 27, 2017

(30) Foreign Application Priority Data
Dec. 27, 2016 (JP) 2016-253835

(51) Int. Cl. G06T 7/70

(52) U.S. Cl. CPC G06T 7/70; G06T 2207/30244

(57) ABSTRACT

To specify a position and a direction of a target having marks within a predetermined space from captured image.

There is provided an estimation system for estimating a position and a posture of a fitting harness, which includes a plurality of marks, which a user wears, and in which the user watches a video image, within a predetermined space. The estimation system stores preset posture data of a case in which the fitting harness is present in each of a plurality of regions different from each other included in the predetermined space, for each of the regions; receives a captured image of the predetermined space in which the fitting harness is included; receives posture information indicating the posture of the fitting harness from the fitting harness; and estimates a region having a possibility that the fitting harness is present among the plurality of regions using the captured image and the preset posture data, and estimates the region by narrowing the preset posture data to be used for a second captured image from the position and the posture in a first captured image based on posture information received after the first captured image is received, when the position and the posture of the fitting harness are estimated based on the second captured image following the first captured image among the sequentially transmitted captured images.

### BACKGROUND OF THE INVENTION

### Field of the Invention

The present invention relates to an estimation system for estimating a position and a posture of a fitting harness present within a predetermined space from a captured image of the predetermined space, an estimation method, and an estimation program.

### Description of Related Art

Recently, augmented reality (AR) technology and virtual reality (VR) technology utilizing head mounted displays have undergone rapid development. When a video image is provided to a user utilizing such a head mounted display, the position of the user is specified and a video image corresponding to the position is also provided to the user.

As a technology of specifying a posture or a position of a person within a predetermined space, Patent Document 1 discloses a technology in which a posture or a position of a person is specified by attaching LEDs (markers) to the person or an object and specifying the attached part of an LED by means of light emitting colors or light emitting patterns of the LEDs and a camera which detects thereof and is synchronized with light emitted from the LEDs (refer to Patent Document 1).

### PATENT DOCUMENTS

[Patent Document 1] Japanese Unexamined Patent Application, First Publication No. 2003-35515

### SUMMARY OF THE INVENTION

Incidentally, when a position of a user wearing a head mounted display is specified based on an image captured by an external camera, it is desirable that the position be specified by connecting the external camera and the head mounted display to each other such that they are synchronized with each other, in order to provide an image corresponding to the position and the direction in real time using a technique as disclosed in Patent Document 1 by causing the external camera and the head mounted display to be synchronized with each other. In this case, it is preferable that the external camera and the head mounted display be connected to each other through a wire in consideration of a communication delay and the like. However, in consideration of limited installation space for various components, usability, and the like in a head mounted display, since wired connection often bothers a user, it is not preferable to provide a connection port to be connected to the external camera. Moreover, the camera needs to be made for connection of synchronization cable. In the case of radio connection, there is a possibility that a problem will occur in synchronization processing.

Therefore, the present invention has been made in consideration of the foregoing problems, and an object thereof is to provide an estimation system which can estimate a position and a posture of a head mounted display within a predetermined space from a video image captured by an external camera without synchronizing the external camera and the head mounted display with each other.

In order to solve the foregoing problems, according to an aspect of the present invention, there is provided an estimation system including a fitting harness which a user wears and in which the user watches a video image, an estimation device which estimates a position and a posture of the fitting harness within a predetermined space, and an image capturing unit which captures an image of the predetermined space. The fitting harness includes a plurality of marks which are provided on an external surface, a detection unit which sequentially detects posture information indicating the posture of the fitting harness, and a first transmission unit which sequentially transmits the posture information to the estimation device. The estimation device includes a storage unit which stores preset posture data of a case in which the fitting harness is present in each of a plurality of regions different from each other included in the predetermined space, for each of the regions; a first reception unit which receives the posture information; a second reception unit which receives a captured image from the image capturing unit; and an estimation unit which estimates a region having a possibility that the fitting harness is present among the plurality of regions using the captured image and the preset posture data, and estimates the region by narrowing the preset posture data to be used for a second captured image from the position and the posture in a first captured image based on posture information received after the first captured image is received, when the position and the posture of the fitting harness are estimated based on the second captured image following the first captured image among the sequentially transmitted captured images.

In order to solve the foregoing problems, according to an aspect of the present invention, there is provided an estimation method of estimating a position and a posture of a fitting harness, which includes a plurality of marks, which a user wears, and in which the user watches a video image, within a predetermined space. The estimation method includes a storing step of storing preset posture data of a case in which the fitting harness is present in each of a plurality of regions different from each other included in the predetermined space, for each of the regions; a first receiving step of receiving a captured image of the predetermined space in which the fitting harness is included; a second receiving step of receiving posture information indicating the posture of the fitting harness from the fitting harness; and an estimating step of estimating a region having a possibility that the fitting harness is present among the plurality of regions using the captured image and the preset posture data, and estimating the region by narrowing the preset posture data to be used for a second captured image from the position and the posture in a first captured image based on posture information received after the first captured image is received, when the position and the posture of the fitting harness are estimated based on the second captured image following the first captured image among the sequentially transmitted captured images.

In order to solve the foregoing problems, according to an aspect of the present invention, there is provided an estimation program for causing a computer to estimate a position and a posture of a fitting harness, which includes a plurality of marks, which a user wears, and in which the user watches a video image, within a predetermined space. The estimation program realizes a storing function of storing preset posture data of a case in which the fitting harness is present in each of a plurality of regions different from each other included in the predetermined space, for each of the regions; a first receiving function of receiving a captured image of the predetermined space in which the fitting harness is included; a second receiving function of receiving posture information indicating the posture of the fitting harness from the fitting harness; and an estimating function of estimating a region having a possibility that the fitting harness is present among the plurality of regions using the captured image and the preset posture data, and estimating the region by narrowing the preset posture data to be used for a second captured image from the position and the posture in a first captured image based on posture information received after the first captured image is received, when the position and the posture of the fitting harness are estimated based on the second captured image following the first captured image among the sequentially transmitted captured images.

In addition, in the estimation system, a unique identifier may be allocated to each of the plurality of marks. The estimation unit may estimate a position and a posture of the fitting harness by estimating which one of the unique identifiers corresponds to the mark of the fitting harness included in the captured image.

In addition, in the estimation system, the posture information may include information indicating directions from a basic position with respect to three axes, and information indicating a state of rotation with respect to each of the axes.

In addition, in the estimation system, the estimation unit may further specify a direction of a normal vector set for each of the marks and estimate the position and the posture of the fitting harness based on the specified normal vector.

In addition, in the estimation system, the plurality of marks may be LEDs.

In addition, in the estimation system, the estimation system may further include a video image transmission device which generates a video image to be displayed in the fitting harness, based on the position and the posture of the fitting harness in the predetermined space estimated by the estimation unit, and transmits the video image.

In addition, in the estimation system, the storage unit may further store the plurality of pieces of received posture information. The estimation unit may perform estimation using the posture information stored in the storage unit when estimation of the region is unable to be executed.

In addition, in the estimation system, the preset posture data may be information in which information for specifying a range included in the predetermined space, and information for calculating presence probability for determining whether or not the fitting harness is included in the range are mapped to each other.

According to the aspect of the present invention, the estimation system can shorten the time required to estimate the position and the direction of the fitting harness in a predetermined space by specifying the preset posture data to be used for estimating the position of the fitting harness in a captured image among multiple pieces of preset posture data by estimating movement of a user wearing the fitting harness between frames of captured images using the posture information (sensing data) from the detection unit (sensor) of the fitting harness.

### BRIEF DESCRIPTION OF THE DRAWINGS

FIG. 1 is a schematic view illustrating an overview of an estimation system.

FIG. 2 is a view illustrating an example of a configuration of the estimation system.

FIG. 3 is a view of the appearance illustrating a state of a user wearing a head mounted display.

FIG. 4 is a perspective view schematically illustrating an overview of an image display system of the head mounted display.

FIG. 5 is a view schematically illustrating an optical configuration of the image display system of the head mounted display.

FIG. 6 is a schematic view describing calibration for detecting a gaze direction.

FIG. 7 is a schematic view describing position coordinates of a user's cornea.

FIG. 8 is a conceptual data scheme illustrating an example of a configuration of preset posture data.

FIG. 9 is a sequence chart illustrating interaction in the estimation system.

FIG. 10 is a flow chart illustrating an operation of an estimation device.

FIG. 11 is a view illustrating an example of a configuration of the estimation system.

### DETAILED DESCRIPTION OF THE INVENTION

Hereinafter, an aspect of an estimation system according to the present invention will be described with reference to the drawings.

### Embodiment

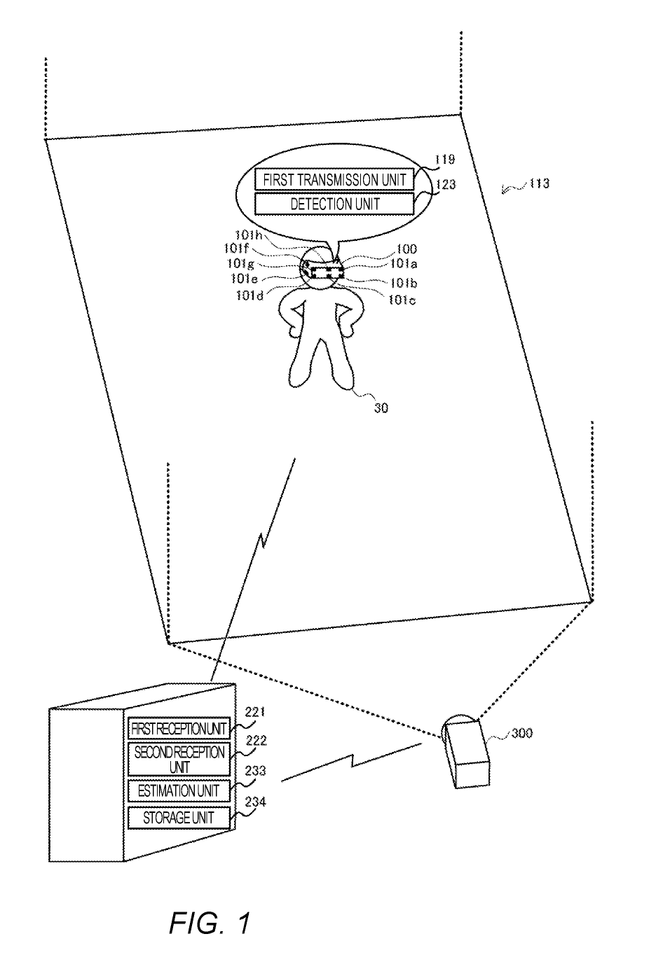

As illustrated in FIG. 1, an estimation system according to the present invention includes a fitting harness 100 which a user wears and in which the user watches a video image, an estimation device 200 which estimates a position and a posture of the fitting harness within a predetermined space, and an image capturing unit 300 which captures an image of the predetermined space. In an estimation system 1, the estimation device 200 estimates the position, the direction, and the posture of the fitting harness 100 within the predetermined space. Therefore, the image capturing unit 300 sequentially captures images of the predetermined space so as to include the entire region of a predetermined space 113. In addition, the fitting harness 100 sequentially detects (senses) its own state. Then, the estimation device 200 sequentially acquires the captured images of the predetermined space from the image capturing unit 300, receives information related to the state of the fitting harness 100 (a change in direction and a change in inclination from a basic posture) from the fitting harness 100, and thereby estimates the state of the fitting harness 100 based on those states. More specifically, the estimation system 1 functions as follows.

The fitting harness 100 is equipment which a user can wear to watch a video image. For example, the fitting harness 100 can be realized by a wearable terminal which can provide a video image to a user, such as a head mounted display and wearable glasses (spectacles).

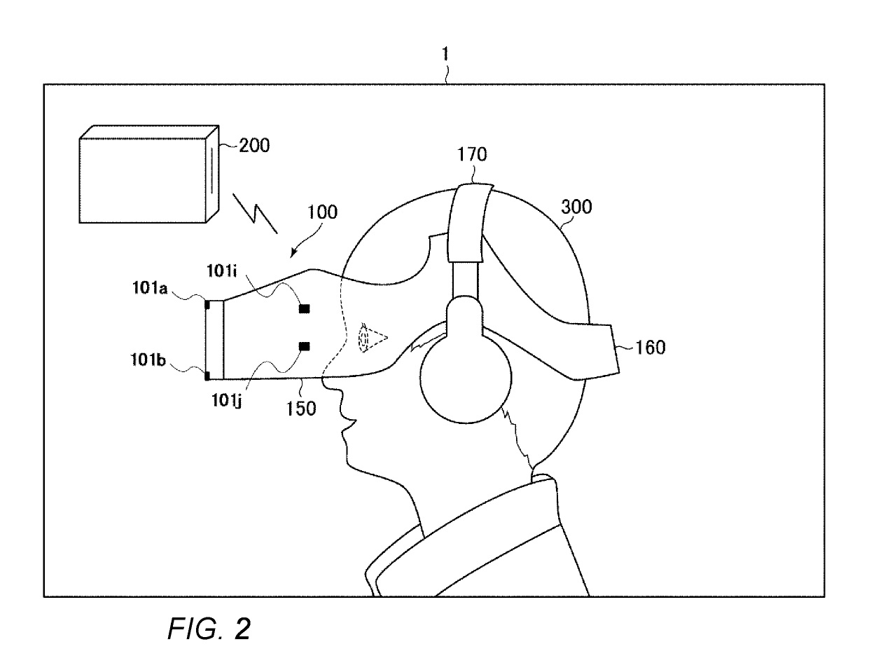

The fitting harness 100 includes a plurality of marks 101a, 101b, 101c, 101d, 101e, 101f, 101g, 101h, 101i, and 101j (refer to FIG. 2 for 101i and 101j) which are provided on the external surface, a detection unit 123 which sequentially detects posture information indicating the posture of the fitting harness, and a first transmission unit 119 which sequentially transmits the posture information to the estimation device 200.

The plurality of marks on the external surface need only be able to be detected within a captured image when a camera captures the image. For example, the marks can be realized by LEDs. The position and the posture of the fitting harness 100 can be specified by assigning IDs to the plurality of marks included in a captured image. As an alternative example of the marks, it is possible to use certain paints which can be specified as marks in the captured image. In addition, the number of marks is not limited to the number illustrated in the drawing and any number of marks may be used.

The detection unit 123 detects the direction or the inclination of the fitting harness 100. For example, the detection unit 123 can be realized by a gyroscope sensor or an acceleration sensor. The detection unit 123 detects the inclination in three-axis directions and the degree of rotation in each axis from the basic posture of the fitting harness 100, and outputs sensing data thereof as the posture information. That is, the posture information includes three-axis acceleration components and rotation information on each axis.

The first transmission unit 119 transmits the posture information detected by the detection unit 123 to the estimation device 200. For example, the first transmission unit 119 can be realized by a communication interface.

The image capturing unit 300 is a camera which captures an image of the predetermined space 113 described above. It is desirable that the image capturing unit 300 capture images so as to include the entire region of the predetermined space 113. Therefore, it is desirable that the angle of view or the disposing position of the camera be adjusted. The image capturing unit 300 captures images of the predetermined space at a predetermined frame rate (for example, 24 fps) and transmits the captured video images to the estimation device 200. The frame rate of images captured by the image capturing unit 300 is lower than the rate of sensing the state of the fitting harness 100 by the detection unit 123 of the fitting harness 100.

The estimation device 200 is a device estimating the position and the posture of the fitting harness 100 which a user wears, within the predetermined space. For example, the estimation device 200 can be realized by a computer system or a server system.

The estimation device 200 includes a storage unit 234, a first reception unit 221, a second reception unit 222, and an estimation unit 233.

The storage unit 234 stores preset posture data 800 of a case in which the fitting harness 100 is present in each of a plurality of regions different from each other included in the predetermined space, for each of the regions. For example, the storage unit 234 can be realized by various types of storage mediums such as a hard disc drive (HDD), a solid state drive (SSD), and a flash memory. Here, the preset posture data 800 is information for specifying a state in which an image can be captured when the fitting harness 100 is present in each of the regions. The preset posture data 800 will be described below in detail.

The first reception unit 221 receives the posture information indicating the posture of the fitting harness 100 transmitted from the fitting harness 100 and can be realized by a communication interface.

The second reception unit 222 receives images captured by the image capturing unit 300 from the image capturing unit 300 and can be realized by a communication interface. The first reception unit 221 and the second reception unit 222 may be realized by the same communication interface.

The estimation unit 233 estimates a region having a possibility that the fitting harness 100 is present among the plurality of regions using the images captured by the image capturing unit 300, and the preset posture data stored in the storage unit 234. In such a case, the estimation unit 233 estimates the region by narrowing the preset posture data to be used for a second captured image from the position and the posture in a first captured image based on posture information received after the first captured image is received, when the position and the posture of the fitting harness 100 are estimated based on the second captured image following the first captured image among the sequentially transmitted captured images. That is, the estimation unit 233 estimates the state (position and posture) of the fitting harness 100 in the predetermined space in an nth+1 frame by estimating how a user (the fitting harness 100) has moved from the position and the posture which has been specified by the estimation device 200 that the fitting harness 100 is present within the predetermined space, based on the posture information detected by the detection unit 123 of the fitting harness 100 in an nth frame in video images captured by the image capturing unit 300. In accordance with this estimation, it is possible to narrow the preset posture data to be used for estimating the position and the posture of the fitting harness 100 within the predetermined space from the captured images.

Hereinafter, the estimation system according to the present invention will be described in detail.

FIG. 2 is a view schematically illustrating an overview of the estimation system 1 according to an embodiment. The estimation system 1 according to the embodiment includes a head mounted display 100 illustrated as an example of the fitting harness 100, and the estimation device 200. Hereinafter, the fitting harness 100 will be disclosed as the head mounted display 100. As illustrated in FIG. 2, a user 30 wears the head mounted display 100 on the head for use.

The estimation device 200 assigns IDs to the marks which are installed on the outer surface of the head mounted display 100 included in a captured image within the predetermined space. Then, the estimation device 200 specifies the position and the direction of the head mounted display 100 in the predetermined space. In addition, the estimation device 200 detects a gaze direction of at least one of the right eye and the left eye of a user wearing the head mounted display 100 and specifies a focal point of the user, that is, a location in a three-dimensional image displayed in the head mounted display which the user gazes at. In addition, the estimation device 200 also functions as a video image generation device which generates video images displayed in the head mounted display 100. As an example without being limited thereto, the estimation device 200 is a device which can reproduce a video image, such as a stationary game machine, a portable game machine, a PC, a tablet, a smartphone, a phablet, a video player, and a television set. The estimation device 200 is connected to the head mounted display 100 by radio or through a wire. In the example illustrated in FIG. 2, the estimation device 200 is connected to the head mounted display 100 by radio. For example, radio connection executed between the estimation device 200 and the head mounted display 100 can be realized using a known radio communication technology such as Wi-Fi (registered trademark) and Bluetooth (registered trademark). As an example without being limited thereto, a transmission of a video image between the head mounted display 100 and the estimation device 200 is executed in compliance with standards, such as Miracast (registered trademark), WiGig (registered trademark), and WHDI (registered trademark).

FIG. 2 illustrates an example of a case in which the head mounted display 100 and the estimation device 200 are separate devices. However, the estimation device 200 may also be built in the head mounted display 100.

The head mounted display 100 includes a housing 150, a fitting harness 160, and headphones 170. The housing 150 accommodates an image display system such as an image display element for presenting a video image to the user 30, and a radio transmission module (not illustrated) such as a Wi-Fi module and a Bluetooth (registered trademark) module. The fitting harness 160 allows the user 30 to wear the head mounted display 100 on the head. For example, the fitting harness 160 can be realized by a belt, an elastic band, or the like. When the user 30 wears the head mounted display 100 using the fitting harness 160, the housing 150 is disposed at a position where the eyes of the user 30 are covered. Therefore, when the user 30 wears the head mounted display 100, the field of view of the user 30 is blocked by the housing 150.

The headphones 170 output audio of a video image reproduced by the estimation device 200. The headphones 170 do not have to be fixed to the head mounted display 100. Even in a state in which the user 30 wears the head mounted display 100 using the fitting harness 160, the user 30 can freely attach and detach the headphones 170.

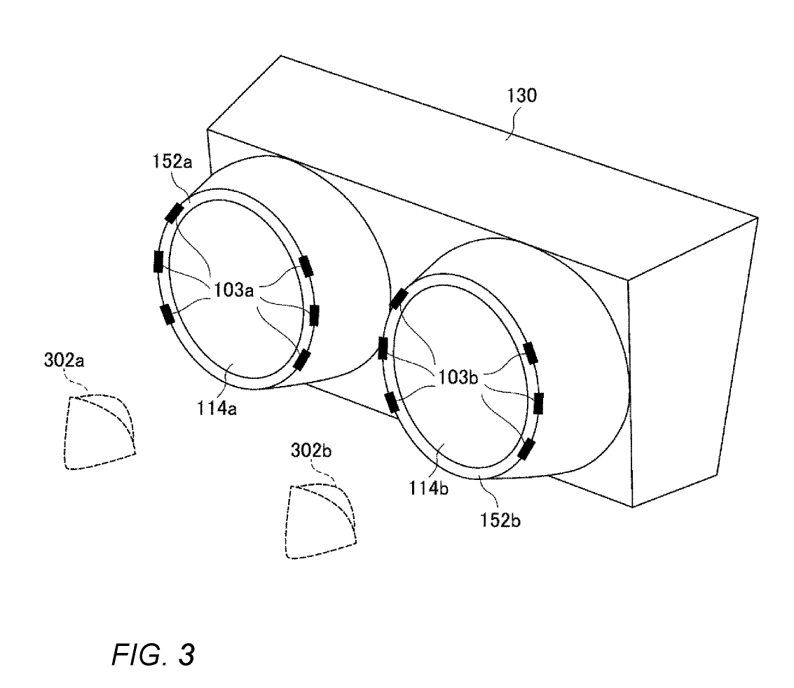

FIG. 3 is a perspective view schematically illustrating an overview of an image display system 130 of the head mounted display 100 according to the embodiment. More specifically, FIG. 3 is a view illustrating a region in the housing 150 according to the embodiment facing cornea 302 of the user 30 when the user wears the head mounted display 100.

As illustrated in FIG. 3, a left eye convex lens 114a is disposed so as to be at a position facing a cornea 302a of the left eye of the user 30 when the user 30 wears the head mounted display 100. Similarly, a right eye convex lens 114b is disposed so as to be at a position facing a cornea 302b of the right eye of the user 30 when the user 30 wears the head mounted display 100. The left eye convex lens 114a and the right eye convex lens 114b are grasped by a left eye lens holder 152a and a right eye lens holder 152b respectively.

Hereinafter, in this specification, unless the left eye convex lens 114a and the right eye convex lens 114b need to be particularly distinguished from each other, they will be simply disclosed as the “convex lens 114”. Similarly, unless the cornea 302a of the left eye of the user 30 and the cornea 302b of the right eye of the user 30 need to be particularly distinguished from each other, they will be simply disclosed as the “cornea 302”. Unless the left eye lens holder 152a and the right eye lens holder 152b need to be particularly distinguished from each other, they will be simply disclosed as the “lens holder 152”.

The lens holder 152 includes a plurality of infrared light sources 103. For the purpose of brevity, in FIG. 3, infrared light sources which irradiate the cornea 302a of the left eye of the user 30 with infrared light are collectively illustrated as infrared light sources 103a, and infrared light sources which irradiate the cornea 302b of the right eye of the user 30 with infrared light are collectively illustrated as infrared light sources 103b. Hereinafter, unless the infrared light sources 103a and the infrared light sources 103b need to be particularly distinguished from each other, they will be simply disclosed as the “infrared light sources 103”. In the example illustrated in FIG. 3, the left eye lens holder 152a includes six infrared light sources 103a. Similarly, the right eye lens holder 152b also includes six infrared light sources 103b. In this way, when the infrared light sources 103 are disposed in the lens holder 152 grasping the convex lens 114 instead of being directly disposed in the convex lens 114, the infrared light sources 103 can be easily attached. The reason is that since the lens holder 152 is generally formed of a resin or the like, the lens holder 152 is easily made for attaching the infrared light sources 103 compared to the convex lens 114 formed of glass or the like.

As described above, the lens holder 152 is a member for grasping the convex lens 114. Therefore, the infrared light sources 103 included in the lens holder 152 are disposed around the convex lens 114. Here, six infrared light sources 103 irradiate each eye with infrared light. However, the number is not limited thereto. At least one infrared light source need only be provided corresponding to each eye. It is desirable that two or more infrared light sources be provided.

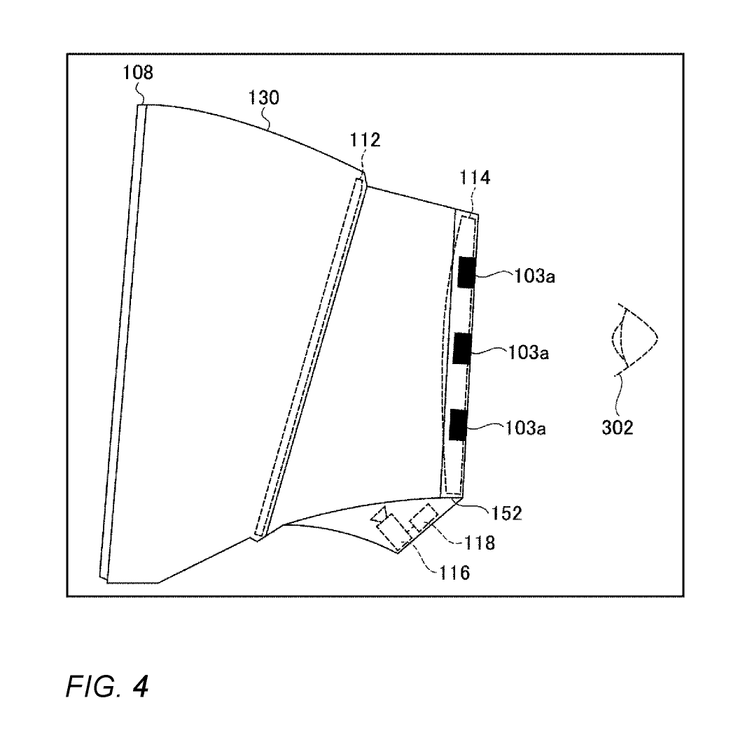

FIG. 4 is a view schematically illustrating an optical configuration of the image display system 130 accommodated in the housing 150 according to the embodiment, when the housing 150 illustrated in FIG. 3 is viewed from the side on the left eye side. The image display system 130 includes the infrared light sources 103, an image display element 108, a hot mirror 112, the convex lens 114, a camera 116, and a first communication unit 118.

The infrared light sources 103 are light sources which can irradiate an object with near-infrared light having a wavelength bandwidth (ranging approximately from 700 nm to 2,500 nm). Generally, near-infrared light is non-visible light having a wavelength bandwidth which cannot be viewed with the naked eyes of the user 30.

The image display element 108 displays an image to be presented to the user 30. The image display element 108 displays the image which is generated by a video image generation unit 232 inside the estimation device 200. The video image generation unit 232 will be described below. For example, the image display element 108 can be realized using a known liquid crystal display (LCD) or a known organic electro-luminescence (EL) display.

The hot mirror 112 is disposed between the image display element 108 and the cornea 302 of the user 30 when the user 30 wears the head mounted display 100. The hot mirror 112 has properties of transmitting visible light generated by the image display element 108 but reflecting near-infrared light.

The convex lens 114 is disposed on a side opposite to the image display element 108 with respect to the hot mirror 112. In other words, the convex lens 114 is disposed between the hot mirror 112 and the cornea 302 of the user 30 when the user 30 wears the head mounted display 100. That is, the convex lens 114 is disposed at a position facing the cornea 302 of the user 30 when the user 30 wears the head mounted display 100.

The convex lens 114 concentrates image displaying light transmitted through the hot mirror 112. Therefore, the convex lens 114 functions as image magnifiers which enlarge the image generated by the image display element 108 and present the enlarged image to the user 30. For convenience of description, only one convex lens 114 is illustrated in FIG. 3. However, the convex lens 114 may be a lens group constituted of a combination of various types of lenses or may be a plane-convex lens having a curvature on one side and having a plane surface on the other side.

The plurality of infrared light sources 103 are disposed around the convex lens 114. The infrared light sources 103 irradiate the cornea 302 of the user 30 with infrared light.

The image display system 130 of the head mounted display 100 according to the embodiment includes two image display elements 108 (not illustrated), so that an image to be presented to the right eye of the user 30 and an image to be presented to the left eye can be independently generated. Therefore, the head mounted display 100 according to the embodiment can present a right eye parallax image and a left eye parallax image to the right eye and the left eye of the user 30 respectively. Accordingly, the head mounted display 100 according to the embodiment can present a stereoscopic video image in perspective to the user 30.

As described above, the hot mirror 112 transmits visible light but reflects near-infrared light. Therefore, the hot mirror 112 transmits irradiated image light from the image display element 108 so that the image light reaches the cornea 302 of the user 30.

The infrared light which has reached the cornea 302 of the user 30 is reflected by the cornea 302 of the user 30 and is headed in a direction toward the convex lens 114 again. This infrared light is transmitted through the convex lens 114 and is reflected by the hot mirror 112. The camera 116 includes a filter blocking visible light and captures an image of near-infrared light reflected by the hot mirror 112. That is, the camera 116 is a near-infrared camera which captures an image of near-infrared light reflected by the cornea of the eye of the user 30 irradiated by the infrared light sources 103.

The image display system 130 of the head mounted display 100 according to the embodiment includes two cameras 116 (not illustrated), that is, a first image capturing unit which captures an image including infrared light reflected by the right eye, and a second image capturing unit which captures an image including infrared light reflected by the left eye. Accordingly, it is possible to acquire an image for detecting the gaze directions for both the right eye and the left eye of the user 30.

The first communication unit 118 outputs an image captured by the camera 116 to the estimation device 200 detecting the gaze direction of the user 30. Specifically, the first communication unit 118 transmits an image captured by the camera 116 to the estimation device 200. A gaze detection unit 231 will be described below in detail. The gaze detection is realized by means of a gaze detecting program executed by a central processing unit (CPU) of the estimation device 200. When the head mounted display 100 has computational resources such as a CPU and a memory, the CPU of the head mounted display 100 may execute a program for realizing a gaze direction detection unit.

In an image captured by the camera 116, bright spots due to near-infrared light reflected by the cornea 302 of the user 30, and an image of the eye including the cornea 302 of the user 30 observed at the wavelength bandwidth of near-infrared light are imaged, and this will be described below. Although near-infrared light from the infrared light source has a certain degree of directivity, the infrared light source also irradiates the eye with diffused light to a certain degree. Therefore, the image of the eye of the user 30 is captured by the diffused light.

Hereinabove, a configuration of presenting an image to the left eye of the user 30 in the image display system 130 according to the embodiment has been mainly described. The same applies to the configuration of presenting an image to the right eye of the user 30.

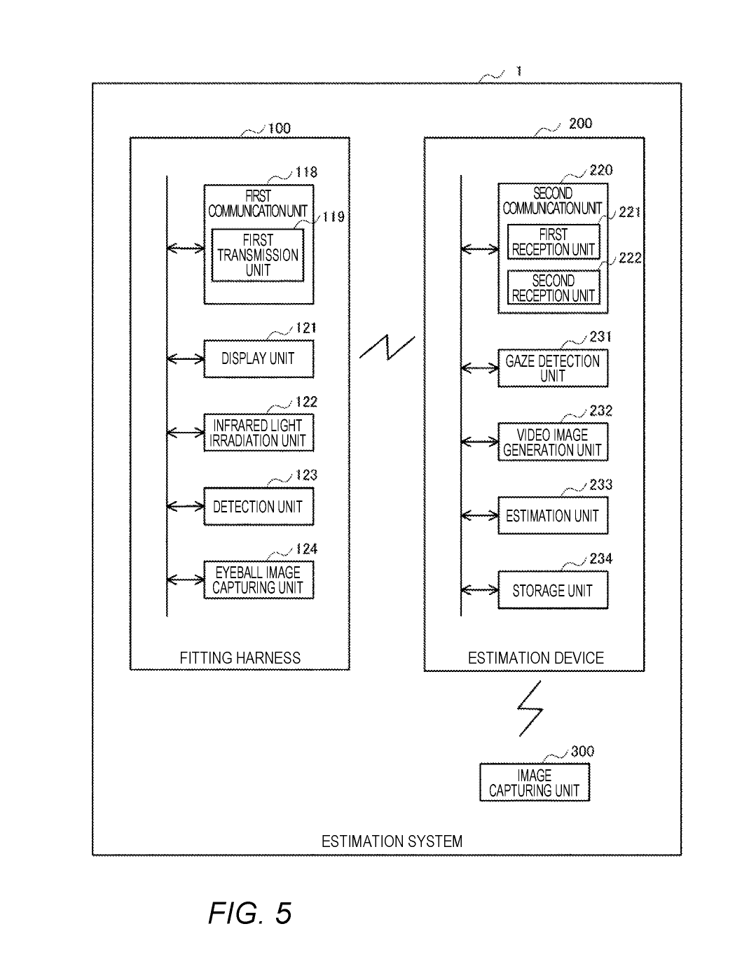

FIG. 5 is a block diagram illustrating a detailed configuration of the estimation system. As illustrated in FIG. 5, the estimation system includes the head mounted display 100, the estimation device 200, and the image capturing unit 300.

As illustrated in FIG. 5, the head mounted display 100 includes the first communication unit 118, a display unit 121, an infrared light irradiation unit 122, the detection unit 123, and an eyeball image capturing unit 124. The first communication unit 118, the display unit 121, the infrared light irradiation unit 122, the detection unit 123, and the eyeball image capturing unit 124 are connected to one another via a bus.

The first communication unit 118 is a communication interface having a function of executing communication with the estimation device 200. As described above, the first communication unit 118 executes communication with a second communication unit 220 through wired communication or radio communication. Examples of adoptable communication standards are described above. The first communication unit 118 transmits image data (data of a captured image) which is sent from the eyeball image capturing unit 124 and is used for gaze detection to the second communication unit 220. In addition, the first communication unit 118 sequentially transmits sensing data detected by the detection unit 123 to the second communication unit 220. In addition, the first communication unit 118 transfers image data or a marker image transmitted from the estimation device 200 to the display unit 121. As an example, the image data is data for displaying a virtual space image or an image of game contents. In addition, the image data may be a pair of parallax images including the right eye parallax image and the left eye parallax image for displaying a three-dimensional image. The first communication unit 118 includes the first transmission unit 119 described above.

The display unit 121 has a function of displaying image data transferred from the first communication unit 118, that is, image data generated by the video image generation unit 232, by means of the image display element 108. In addition, the display unit 121 displays a marker image output from the video image generation unit 232 in coordinates designated in the image display element 108.

The infrared light irradiation unit 122 controls the infrared light sources 103 and irradiates the right eye or the left eye of a user with near-infrared light.

The detection unit 123 is a sensor having a function of detecting a state of the head mounted display 100. For example, the detection unit 123 is realized by a gyroscope sensor, an acceleration sensor, or the like. The detection unit 123 is a so-called six-axis sensor which detects three-axis components having one axis included in a horizontal plane as an X-axis, a Y-axis at right angle to the X-axis, and a Z-axis perpendicular to a plane formed by the X-axis and the Y-axis. The detection unit 123 also detects information related to rotation of the three-axis components and outputs the detected information. Those detected values (sensing data) actually indicate the amount of change from the basic posture and are output as posture information. The detection unit 123 transfers the detected sensing data to the first communication unit 118.

The eyeball image capturing unit 124 uses the camera 116 to capture an image including the eyes of a user and including near-infrared light reflected by each of the eyes of the user 30. In addition, the eyeball image capturing unit 124 captures an image including the eyes of a user gazing at the marker image displayed by the image display element 108. The eyeball image capturing unit 124 transfers the captured image to the first communication unit 118. The head mounted display 100 may be configured to include an image processing unit for performing image processing, such that an image captured by the eyeball image capturing unit 124 is subjected to predetermined image processing and is transmitted from the first communication unit 118 to the second communication unit 220.

The estimation device 200 includes the second communication unit 220, the gaze detection unit 231, the video image generation unit 232, the estimation unit 233, and the storage unit 234.

The second communication unit 220 is a communication interface having a function of executing communication with the first communication unit 118 of the head mounted display 100. As described above, the second communication unit 220 executes communication with the first communication unit 118 through wired communication or radio communication. The second communication unit 220 transmits image data for displaying a virtual space image including one or more advertisement transferred from the video image generation unit 232, a marker image used for calibration, or the like to the head mounted display 100. In addition, with respect to the gaze detection unit 231, the second communication unit 220 transfers an image including the eyes of a user gazing at the marker image which is captured by the eyeball image capturing unit 124 and is transmitted from the head mounted display 100, and a captured image of the eyes of a user looking at the image displayed based on the image data output by the video image generation unit 232. In addition, with respect to the estimation unit 233, the second communication unit 220 transfers an image which is transmitted from the image capturing unit 300, that is, a captured image of the predetermined space in which a user wearing the head mounted display 100 is present.

The second communication unit 220 includes the first reception unit 221 and the second reception unit 222 described above. The first reception unit 221 and the second reception unit 222 may share one receiving circuit. In such a case, received data can be distinguished by checking a header or the like of the received data.

The gaze detection unit 231 receives image data (captured image) for a gaze detection of the right eye of a user from the second communication unit 220 and detects the gaze direction of the right eye of a user. Similarly, the gaze detection unit 231 receives image data for a gaze detection of the left eye of a user from the second communication unit 220 and detects the gaze direction of the left eye of the user 30. More specifically, the gaze detection unit 231 specifies a location in an image displayed by the image display element 108 which a user gazes at, using a gaze detection technique (will be described below). The gaze detection unit 231 transfers the location, which a user gazes at (gaze coordinates in the image display element 108), to the video image generation unit 232. The gaze detection unit 231 can be realized by a processor.

The video image generation unit 232 generates image data to be displayed in the display unit 121 of the head mounted display 100 and transfers the generated image data to the second communication unit 220. In addition, the video image generation unit 232 generates a marker image for calibration in order to perform the gaze detection and transfers the generated marker image to the second communication unit 220 together with the display coordinate position, so that the data is transmitted to the head mounted display 100. In addition, the video image generation unit 232 generates a video image based on the user's gaze output from the gaze detection unit 231 and transfers the data to the second communication unit 220. For example, the video image generation unit 232 generates video image data in which resolution of a predetermined range including the gaze position detected by the gaze detection unit 231 is higher than the resolution of locations other than the predetermined range and transfers the generated video image data to the second communication unit 220. In addition, the video image generation unit 232 generates a video image corresponding to the position and the direction of the head mounted display 100 in the predetermined space transferred from the estimation unit 233 and transfers the generated video image to the second communication unit 220. For example, the video image generation unit 232 can be realized by a processor or a graphic engine.

The estimation unit 233 estimates the position and the posture within the predetermined space of the head mounted display 100 from the received captured image and the preset posture data 800 which is stored in the storage unit 234. The estimation unit 233 specifies each of the marks installed on the outer surface of the head mounted display 100 present within the predetermined space, from an image of the predetermined space captured by the image capturing unit 300 and allocates IDs for marks set in advance to the marks in the captured image. That is, the estimation unit 233 specifies marks corresponding to the marks in the captured image among the marks installed on the head mounted display 100. Then, the estimation unit 233 estimates the presence position and the direction within the predetermined space of the head mounted display 100 using the plurality of pieces of preset posture data stored in the storage unit 234.

In addition, the estimation unit 233 estimates movement of a user (head mounted display 100) between frames of the captured images based on the transferred posture information and estimates how the user (head mounted display 100) has moved. Then, the estimation unit 233 specifies preset posture data to be used for estimating the actual position and posture of the head mounted display 100, based on the position and the posture after the estimation. For example, the estimation unit 233 can be realized by a processor.

The storage unit 234 is a storage medium which stores various types of programs and data required for the estimation device 200 to operate. For example, the storage unit 234 is realized by a hard disc drive (HDD) and a solid state drive (SSD). The storage unit 234 stores the gaze detecting program used by the gaze detection unit 231 for the gaze detection, an estimation program used by the estimation unit 233 for estimating the position of the head mounted display 100 which a user wears within the predetermined space, eyeball-captured images (video image) received from the head mounted display 100, sensing data detected by the detection unit 123, captured images received from the image capturing unit 300, and the like.

Hereinabove, the configuration of the estimation device 200 has been described. Next, detection of a user's gaze point will be described.

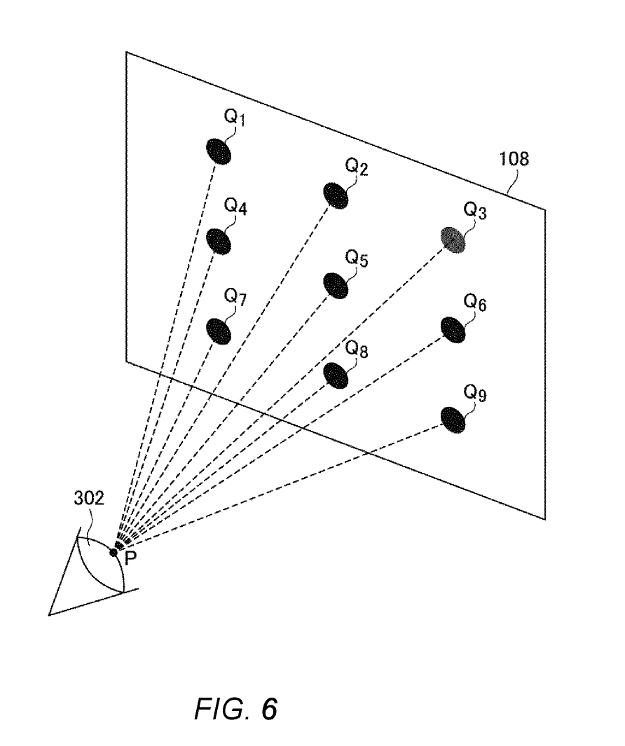

FIG. 6 is a schematic view describing calibration for detecting the gaze direction according to the embodiment. The detection of the gaze direction of the user 30 is realized by the gaze detection unit 231 inside the estimation device 200 analyzing a video image which is captured by the camera 116 and is output by the first communication unit 118 to the estimation device 200.

The video image generation unit 232 generates nine points (marker images) from points Q₁ to Q₉ as illustrated in FIG. 6 and causes the image display element 108 of the head mounted display 100 to display the points. The estimation device 200 causes the user 30 to gaze at the point Q₁ to the point Q₉ in order. In this case, the user 30 is required to gaze at each of the points by only movement of the eyeballs as much as possible without moving the neck. The camera 116 captures an image including the cornea 302 of the user 30 when the user 30 gazes at the nine points constituted of the points Q₁ to Q₉.

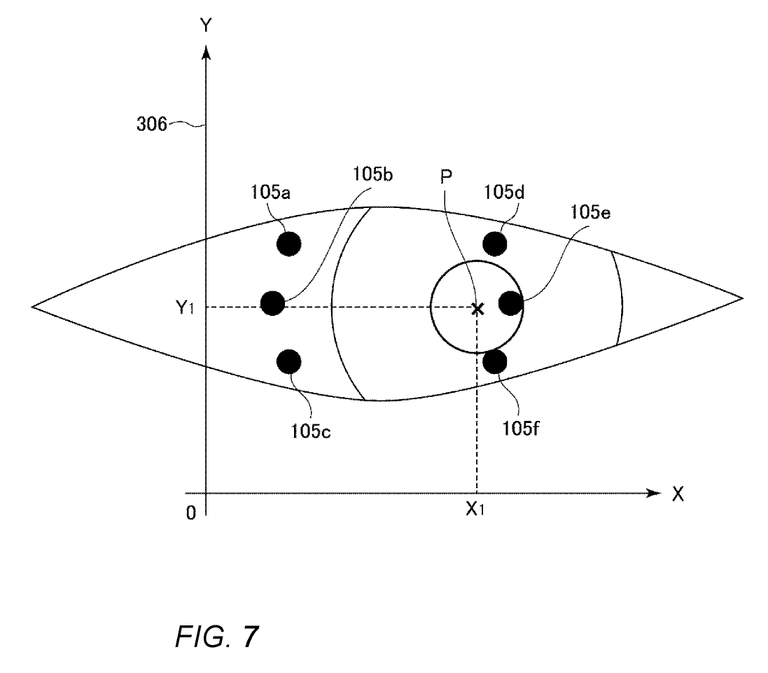

FIG. 7 is a schematic view describing position coordinates of the cornea 302 of the user 30. The gaze detection unit 231 inside the estimation device 200 analyzes an image captured by the camera 116 and detects bright spots 105 derived from infrared light. When the user 30 gazes at each of the points with only movement of the eyeballs, even when the user gazes at any point, it is assumed that the positions of the bright spots 105 do not move. Therefore, the gaze detection unit 231 sets a two-dimensional coordinate system 306 in an image captured by the camera 116 based on the detected bright spots 105.

In addition, the gaze detection unit 231 detects a center P of the cornea 302 of the user 30 by analyzing the image captured by the camera 116. For example, this process can be realized using known image processing such as Hough transform and edge extraction processing. Accordingly, the gaze detection unit 231 can acquire the coordinates of the center P in the cornea 302 of the user 30 in the set two-dimensional coordinate system 306.

In FIG. 6, the coordinates of each of the point Q₁ to the point Q₉ in the two-dimensional coordinate system set in a display screen displayed by the image display element 108 are expressed as Q₁(x₁, y₁)^{T}, Q₂(x₂, y₂)^{T}, and so on to Q₉(x₉, y₉)^{T}. For example, each set of the coordinates serves as the number for a pixel positioned at the center of each point. In addition, the centers P of the cornea 302 of the user 30 when the user 30 gazes at the point Q₁ to the point Q₉ are expressed as points P₁ to P₉. In this case, the coordinates of each of the points P₁ to P₉ in the two-dimensional coordinate system 306 are expressed as P₁(X₁, Y₁)^{T}, P₂(X₂, Y₂)^{T}, and so on to P₉(X₉, Y₉)^{T}. The factor T indicates a translocation of a vector or a matrix.

Here, the matrix M having a size of 2×2 is defined as the following Expression (1).

$$M = ( \begin{matrix}{m}_{11} & {m}_{12} \\ {m}_{21} & {m}_{22}\end{matrix} ) \qquad ( 1 )$$

In this case, when the matrix M satisfies the following Expression (2), the matrix M becomes a matrix of a gaze direction of the user 30 projected on a plane of an image displayed by the image display element 108.

Q_{N}=MP_{N}(N=1, and so on to 9) (2)

When Expression (2) is specifically written, the following Expression (3) is established.

$$( \begin{matrix}{x}_{1} & {x}_{2} & … & {x}_{9 } \\ {y}_{1} & {y}_{2} & … & {y}_{9}\end{matrix} ) = ( \begin{matrix}{m}_{11} & {m}_{12} \\ {m}_{21} & {m}_{22}\end{matrix} ) ( \begin{matrix}{X}_{1} & {X}_{2} & … & {X}_{9} \\ {Y}_{1} & {Y}_{2} & … & {Y}_{9}\end{matrix} ) \qquad ( 3 )$$

When Expression (3) is rearranged, the following Expression (4) is obtained.

$$\begin{matrix}[ Math . 4 ] & \\ ( \begin{matrix}{x}_{1} \\ {x}_{2} \\ ⋮ \\ {x}_{9} \\ {y}_{1} \\ {y}_{2} \\ ⋮ \\ {y}_{9}\end{matrix} ) = ( \begin{matrix}{X}_{1} & {Y}_{1} & 0 & 0 \\ {X}_{2} & {Y}_{2} & 0 & 0 \\ ⋮ & ⋮ & ⋮ & ⋮ \\ {X}_{9} & {X}_{9} & 0 & 0 \\ 0 & 0 & {X}_{1} & {Y}_{1} \\ 0 & 0 & {X}_{2} & {Y}_{2} \\ ⋮ & ⋮ & ⋮ & ⋮ \\ 0 & 0 & {X}_{9} & {Y}_{9}\end{matrix} ) ( \begin{matrix}{m}_{11} \\ {m}_{12} \\ {m}_{21} \\ {m}_{22}\end{matrix} ) \\ y = ( \begin{matrix}{x}_{1} \\ {x}_{2} \\ ⋮ \\ {x}_{9} \\ {y}_{1} \\ {y}_{2} \\ ⋮ \\ {y}_{9}\end{matrix} ) , A = ( \begin{matrix}{X}_{1} & {Y}_{1} & 0 & 0 \\ {X}_{2} & {Y}_{2} & 0 & 0 \\ ⋮ & ⋮ & ⋮ & ⋮ \\ {X}_{9} & {X}_{9} & 0 & 0 \\ 0 & 0 & {X}_{1} & {Y}_{1} \\ 0 & 0 & {X}_{2} & {Y}_{2} \\ ⋮ & ⋮ & ⋮ & ⋮ \\ 0 & 0 & {X}_{9} & {Y}_{9}\end{matrix} ) , x = ( \begin{matrix}{m}_{11} \\ {m}_{12} \\ {m}_{21} \\ {m}_{22}\end{matrix} ) & ( 4 )\end{matrix}$$

In this case, the following Expression (5) is obtained.

y=Ax (5)

In Expression (5), the elements of the vector y are known since they are the coordinates of the points Q₁ to Q₉ which the gaze detection unit 231 causes the image display element 108 to display. In addition, the elements of the matrix A can be acquired since they are the coordinates of the apex point P on the cornea 302 of the user 30. Therefore, the gaze detection unit 231 can acquire the vector y and the matrix A. The vector x, that is, a vector in which the elements of the conversion matrix M are arranged is unknown. Therefore, when the vector y and the matrix A are known, the problem of estimating the matrix M becomes a problem of obtaining the unknown vector x.

The Expression (5) becomes the priority problem when the number of expressions (that is, the number of points Q presented to the user 30 at the time of calibration of the gaze detection unit 231) is greater than the number of unknown values (that is, four as the number of elements of the vector x). The example indicated in Expression (5) is the priority problem since the number of expressions is nine.

The error vector between the vector y and the vector Ax is expressed as the vector e. That is, e=y-Ax is established. In this case, in terms of minimizing the sum of squares of the elements of the vector e, an optimal vector xₒₚₜ is obtained by the following Expression (6).

xₒₚₜ=(A^{T}A)⁻¹A^{T}y (6)

Here, “−1” indicates an inverse matrix.

The gaze detection unit 231 configures the matrix M of Expression (1) by using the obtained elements of the vector xₒₚₜ. Accordingly, the gaze detection unit 231 can estimate the location which the right eye of the user 30 gazes at on a moving image displayed by the image display element 108, in accordance with Expression (2) using the coordinates of the apex point P and the matrix M of the cornea 302 of the user 30. Here, the gaze detection unit 231 further receives information on the distance between the eyes of a user and the image display element 108 from the head mounted display 100 and calibrates the estimated values of the coordinates which a user gazes at, in accordance with the information on the distance therebetween. A deviation in the estimation of the gaze position due to the distance between the eyes of a user and the image display element 108 may be ignored as an error range. Accordingly, the gaze detection unit 231 can calculate the right eye gaze vector connecting the gaze point of the right eye on the image display element 108 and the apex point on the cornea of the user's right eye. Similarly, the gaze detection unit 231 can calculate the left eye gaze vector connecting the gaze point of the left eye on the image display element 108 and the apex point on the cornea of the user's left eye. It is possible to specify a user's gaze point on a two-dimensional plane with the gaze vector of only one eye. When, the gaze vectors of both eyes are obtained, it is also possible to calculate information on the user's gaze point in the depth direction. In this way, the estimation device 200 can specify the user's gaze point. The method of specifying the gaze point described herein is an example. The user's gaze point may be specified using a technique other than that described in the present embodiment.

The image capturing unit 300 is an ordinary camera having a function of capturing an image of the predetermined space and transmitting the captured video image to the estimation device 200. The image capturing unit 300 sequentially transmits captured video images to the estimation device 200 at the frame rate set in advance. The frame rate is a rate lower than the sensing rate of detection of the detection unit 123 and the rate of transmitting the sensed data from the head mounted display 100 to the estimation device 200. The image capturing unit 300 may be connected to the estimation device 200 either through a wire or by radio. The image capturing unit 300 need only be able to forward data of a captured video image, and any communication protocol may be used.

Hereinabove, the configuration of the estimation system 1 has been described.

### <Data>

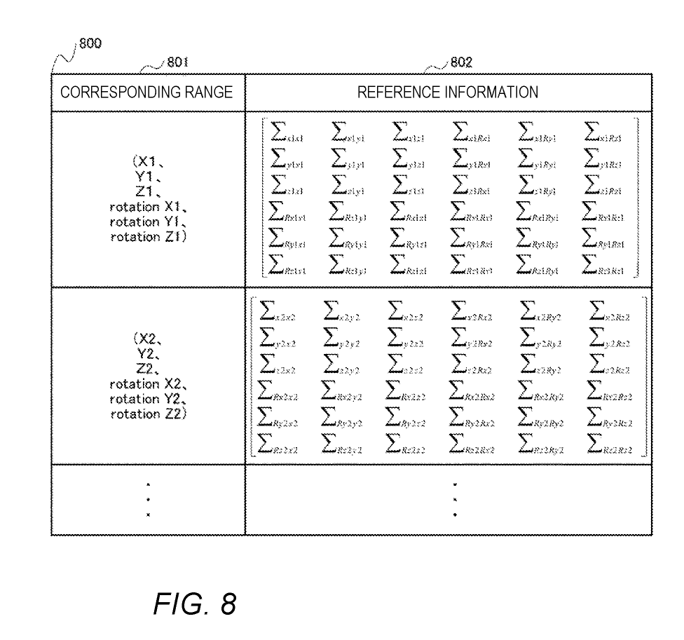

FIG. 8 is a conceptual data scheme illustrating an example of a data configuration of the preset posture data 800 stored in the storage unit of the estimation device 200. The preset posture data 800 is information for calculating the presence probability of a target (HMD) in a region in the predetermined space, based on an image. FIG. 8 is an example thereof.

As illustrated in FIG. 8, the preset posture data 800 is data in which a corresponding range 801 in the predetermined space is mapped to reference information 802 indicating positions which can be realized as the disposition relationship of each mark in its corresponding range. In other words, the preset posture data 800 is information indicating a state which the head mounted display 100 can be situated if the head mounted display 100 is present in each of ranges set in advance in a case in which the ranges are set within the predetermined space.

The corresponding range 801 is information indicating a coordinate range in the predetermined space. Here, the corresponding range 801 is indicated as a coordinate position which becomes the center of the range. The corresponding range is within the predetermined range having its coordinate position as the center. As an example of the corresponding range 801, FIG. 8 illustrates a case of using six indexes constituted of the values of the coordinates (x, y, z) which becomes the center of the range, and the values (rotation x, rotation y, rotation z) indicating the rotation angles of the axes (x-axis, y-axis, z-axis). Here, the x-axis and the y-axis may be axes included in a horizontal plane at right angles to each other, and the z-axis may be an axis at right angles to both the x-axis and the y-axis.

The reference information 802 is information indicating a disposition relationship between the marks and designated marks if the head mounted display 100 is present in the corresponding range 801. For example, the reference information 802 can be expressed in a covariance matrix indicating probability that the head mounted display 100 is present in the corresponding range corresponding thereto, but the reference information 802 is not limited thereto. The reference information 802 may have any form as long as the reference information 802 is information with which the position or the posture of the head mounted display 100 can be specified in the reference image. As an example, when the vector indicating the position is v=(x, y, z)^{T} (T denotes the translocation), and the rotation vector indicating rotation of an arbitrary axis is R=(Rx, Ry, Rz), the reference information 802 can be expressed by the matrix expression shown in FIG. 8. In the matrix expression, the factor Σxx denotes a covariance value. The covariance value indicates openness (probability) in the predetermined space. For example, the factor Σxx denotes that the probability with respect to a certain direction changes. Even when the matrix expression shown in FIG. 8 is a diagonal matrix, the estimation unit can execute estimation of the position of a user in the predetermined space of the user wearing the head mounted display 100. In such a case, it is possible to reduce the computation load at the time of estimation.

The estimation unit 233 specifies the positions of the marks included within the captured image and calculates the probability that the head mounted display 100 is assumed to be in the corresponding range corresponding thereto, based on specified positions of the marks and the reference information 802 including the preset posture data. As described above, the preset posture data 800 in FIG. 8 is an example. Therefore, for example, grids obtained by dividing the predetermined space in a grid shape may be used as the corresponding range 801. The grids may be formed in a concentric sphere shape or a cube shape. In addition, alternatively, the shapes may be combined together. In addition, in this case, the covariance value is used. However, as a technique of calculating the presence probability, a different technique using other than the covariance value may be used.

### <Operation>

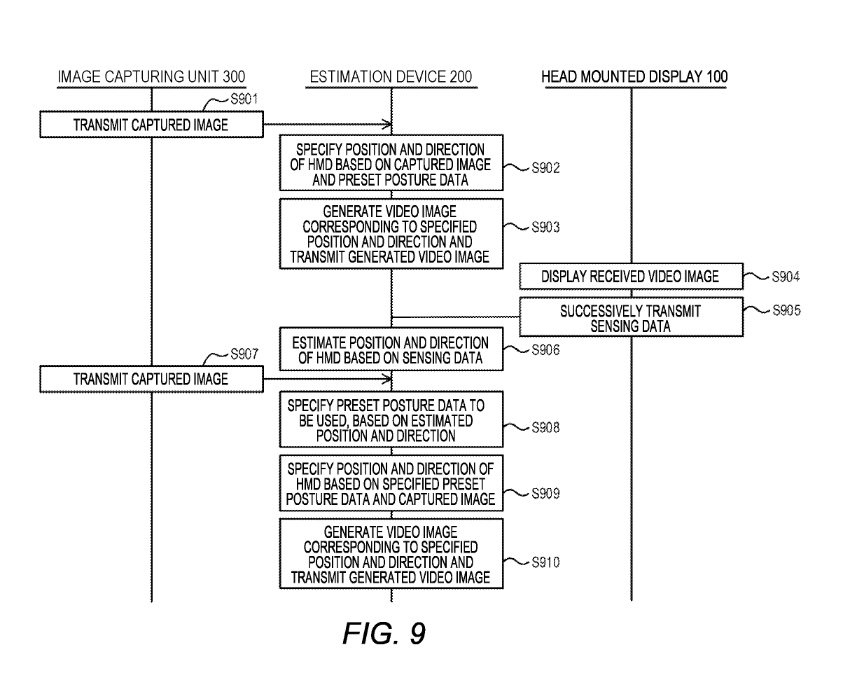

FIG. 9 is a sequence chart illustrating interaction among the devices in the estimation system 1. As illustrated in FIG. 9, the image capturing unit 300 sequentially transmits captured images (video images) to the estimation device 200. The image capturing unit 300 transmits the captured video images (here, a first frame) to the estimation device 200 (Step S901).

The estimation device 200 which has received the captured images assigns IDs to the marks of the HMD in the captured images by using the received captured images and the plurality of pieces of stored preset posture data and specifies the position and the direction of the head mounted display 100 in the predetermined space (captured space) (Step S902).

Then, the estimation device 200 generates a video image corresponding to the specified position and direction of the head mounted display 100 and transmits the generated video image to the head mounted display 100 (Step S903).

The head mounted display 100 which has received the video image displays the received video image (Step S904) and provides the video image to the user 30.

While receiving the video image from the estimation device 200, the head mounted display 100 sequentially transmits sensing data (posture information) such as a change in direction and acceleration from its standard position to the estimation device 200 (Step S905). Since the sensing rate of the sensor installed in the head mounted display 100 is higher than the frame rate of images captured by the image capturing unit 300, a plurality of pieces of sensing data are transmitted to the estimation device 200 until the image capturing unit 300 transmits a next frame after one frame is transmitted. For example, when the image capturing unit 300 captures images at 24 fps and the sensing rate is 240 ps, until the image capturing unit 300 sends a next frame after one frame is sent, the head mounted display 100 transmits approximately ten pieces of sensing data.

Based on the sequentially transmitted sensing data (posture information), the estimation device 200 estimates the position and the direction of the head mounted display 100 by adding the amount of change in the position and the posture of the head mounted display 100 to the position and the direction of the HMD specified in Step S902, based on the pieces of sequentially received posture information (Step S906).

The image capturing unit 300 transmits a next captured frame to the estimation device 200 (Step S907).

Based on the estimated position and the posture, the estimation device 200 specifies the preset posture data used for specifying the position and the posture of the head mounted display based on the captured image, among the pieces of preset posture data stored in the storage unit (Step S908).

When the preset posture data is specified, the estimation device 200 specifies the position and the posture of the head mounted display 100 within the predetermined space using the narrowed preset posture data (Step S909). Then, the estimation device 200 generates video image data corresponding to the specified position and the posture and transmits the generated video image data to the head mounted display 100 (Step S910).

In the related art, in order to specify a position of the head mounted display 100 from the captured image and the preset posture data, it has been required to compute the preset posture data in a round-robin manner from the beginning. However according to the estimation system 1 of the present embodiment, it is possible to narrow the preset posture data to be used for specifying the position and the direction by estimating the position of the head mounted display 100 within the predetermined space from the pieces of posture information sequentially transmitted by the head mounted display 100.

Therefore, the position in the predetermined space can be specified from the captured images without connecting the fitting harness 100 and the estimation device 200 to each other through a wire for synchronization.

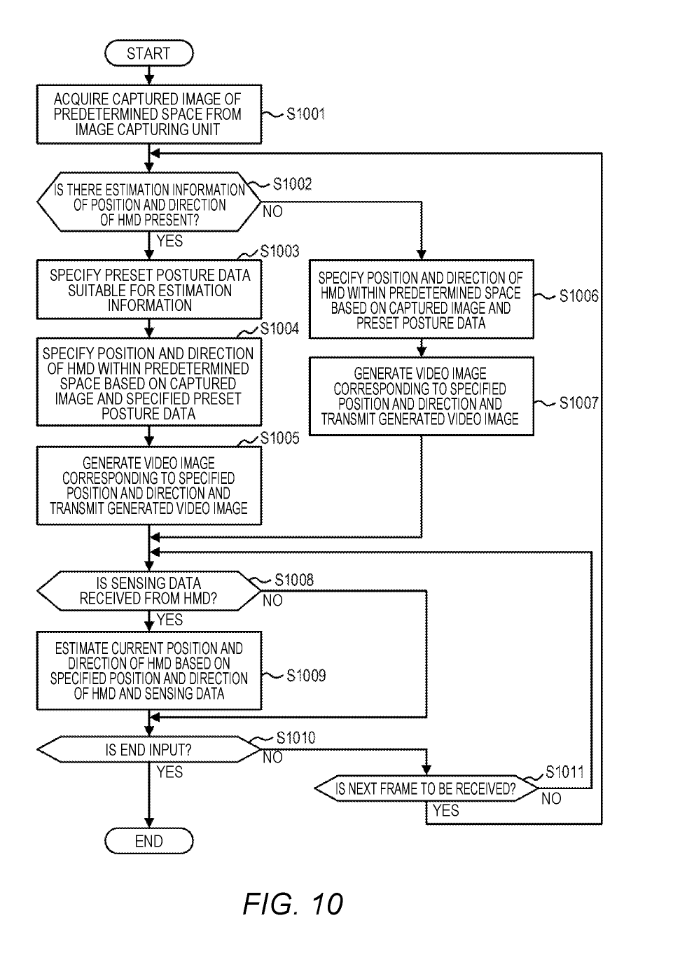

Hereinafter, an operation of the estimation device 200 for realizing interaction illustrated in the sequence chart of FIG. 9 will be described using the flow chart illustrated in FIG. 10.

FIG. 10 is a flow chart illustrating an operation of the estimation device 200.

The second communication unit 220 of the estimation device 200 receives a captured image of the predetermined space from the image capturing unit 300 (Step S1001). The second communication unit 220 transfers the received captured image to the estimation unit 233.

The estimation unit 233 determines whether or not estimated information estimating the position and the direction of the head mounted display 100 is stored in the storage unit 234 (Step S1002).

When the estimated information is stored in the storage unit 234 (YES in Step S1002), that is, when the received captured image is a second frame or a frame thereafter, the estimation unit 233 specifies the preset posture data corresponding to the estimated information stored in the storage unit 234 (Step S1003). That is, the estimation unit 233 specifies the preset posture data to which the coordinates of the center of the region at a part closest to the position indicated by the estimated information is mapped.

The estimation unit 233 specifies the position of the head mounted display 100 included within the captured image, based on the captured image and the specified preset posture data. In this case, when the calculated probability exceeds a predetermined threshold value, the estimation unit 233 estimates that the head mounted display 100 is present in the corresponding range corresponding thereto using the reference information 802 and the captured image. Then, the estimation unit 233 specifies marks of the IDs corresponding to the marks in the captured image with respect to each of the marks installed in the head mounted display in the captured image. Then, the estimation unit 233 specifies the position and the direction of the head mounted display 100 within the predetermined space by assigning IDs to the marks (Step S1004). The estimation unit 233 transfers the specified position and direction to the video image generation unit 232.

The video image generation unit 232 generates a video image corresponding to the specified position and direction. The video image corresponding to the specified position and direction denotes a video image viewed in that direction when being present at the specified position. The video image generation unit 232 transfers the generated video image to the second communication unit 220, and the second communication unit 220 transmits the transferred video image to the head mounted display 100 (Step S1005).

Meanwhile, in Step S1002, when there is no estimated information (NO in Step S1002), the estimation unit 233 estimates in order in a round-robin manner whether the preset posture data is at the position using the captured image (Step S1005). That is, the estimation unit 233 specifies marks as the marks within the received captured image and specifies a corresponding range 801 having the highest possibility that the marks are positioned within the predetermined space 113 using each covariance matrix of the reference information 802. Since the probability that the marks are present at the positions indicated in each piece of the preset posture data is obtained using each piece of the preset posture data and the captured image, it takes time to specify the positions compared to the state in which the preset posture data is not narrowed. The estimation unit 233 transfers the specified position and direction to the video image generation unit 232.

The video image generation unit 232 generates a video image corresponding to the specified position and direction. The video image corresponding to the specified position and direction denotes a video image viewed in that direction when being present at the specified position. The video image generation unit 232 transfers the generated video image to the second communication unit 220, and the second communication unit 220 transmits the transferred video image to the head mounted display 100 (Step S1007).

In Step S1008, the second communication unit 220 of the estimation device 200 determines whether or not the sensing data is received from the head mounted display 100 (Step S1008).

When the sensing data is received (YES in Step S1008), the estimation unit 233 estimates current position and direction of the head mounted display 100 by adding the moving amount of the case of the movement indicated by the sensing data and the moving direction, with respect to the specified position and direction of the head mounted display 100. The estimation unit 233 causes the storage unit 234 to store the estimated position and direction as the estimated information (Step S1009).

The estimation device 200 determines whether or not an input for ending displaying of video images in the head mounted display 100 is received (Step S1010). When an input is received (YES in Step S1010), the processing illustrated in FIG. 10 ends.

When no input is received (NO in Step S1010), the estimation device 200 determines whether or not the second communication unit 220 has received a next captured image (frame) (Step S1011). When no frame is received next (NO in Step S1011), the processing returns to Step S1008. When a next frame is received (YES in Step S1011), the processing returns to Step S1002 and processing thereafter is executed.

In the beginning, since the preset posture data cannot be narrowed using the sensing data detected by the detection unit 123 (when NO in Step S1002), the position and the posture of the head mounted display 100 within the predetermined space are estimated in a round-robin manner. However, it is possible to expect improvement of the processing speed when specifying the position thereafter.

When specifying the marks captured in the captured image, sometimes a plurality of marks are specified as candidates. For example, when a user is facing a side surface with respect to the image capturing unit 300, there is a possibility of determining that the mark in the captured image is the mark 101a and there is a possibility of determining that the mark in the captured image is the mark 101g.

In preparation for when it is not possible to uniformly specify the marks corresponding to the marks in the captured image, the storage unit 234 holds information on the direction in which each of the marks is installed to emit light, with respect to the head mounted display 100. Specifically, the storage unit 234 holds normal vector information for each of the marks. Then, when the marks in the captured image are narrowed to a plurality of marks, the estimation unit 233 can specify marks having high probability of being captured in the captured image, based on the sensing data transferred from the head mounted display 100, and the normal vector for each of the marks stored in advance.

### CONCLUSION

According to the estimation system of the present embodiment, when the position and the posture of a user (head mounted display) within the predetermined space are estimated based on the video images captured by the image capturing unit, it is possible to estimate the position and the posture in a next frame using the sensing data of the head mounted display 100 by supplementing the information between frames. Therefore, it is possible to shorten the processing time required to specify the position and the estimation of the head mounted display in a next frame.

<Supplementation>

The estimation system according to the embodiment is not limited to the embodiment described above, and it is natural to be realized by a different technique. Hereinafter, various modification examples will be described.

(1) In the embodiment described above, the estimation unit 233 is described to be able to estimate the position of a user wearing the fitting harness 100 at all times. However, there are cases in which a required input cannot be obtained and the position and the posture of a user (fitting harness 100) in the predetermined space cannot be estimated due to some reason, for example, various reasons such as unsatisfactory sensing of the sensor and a communication error resulting in incomplete transfer of the sensing data sensed by the sensor.

Therefore, in consideration of such circumstances, the estimation device 200 of the estimation system 1 may include the following configuration. That is, the storage unit 234 may be configured to suitably store and hold the posture information received by the second communication unit 220. In the posture information stored herein, posture information nearest to the current time is stored in priority. Otherwise, as the posture information to be stored, the posture information assumed to have high probability of estimation of the position and the posture of the fitting harness 100 estimated based on the posture information may be stored.

Then, when the second communication unit 220 cannot receive the posture information required for the estimation unit 233 to perform estimation for a certain period of time, the estimation unit 233 may perform estimation based on posture information which is not the latest information stored in the storage unit 234. In this case, the posture information used for estimation may be only the latest posture information stored in the storage unit 234 or may be the average value of a plurality of pieces of latest posture information.

Otherwise, a function indicating the changes in the position and the direction of the fitting harness may be generated based on the plurality of pieces of latest posture information, a current time may be input to the function, and the posture information may be estimated. Then, the reference information to be used may be specified based on the estimated posture information, and the position and the posture of the fitting harness 100 in the predetermined space 113 may be estimated. When a posture is estimated in a case in which there is no information from the sensor, the posture is estimated based on the rule using previous information, information before the previous information, a method of re-estimation, or a combination thereof. As the rule, for example, it is possible to employ techniques such as the cycle of movement and prediction of the posture based on human engineering.

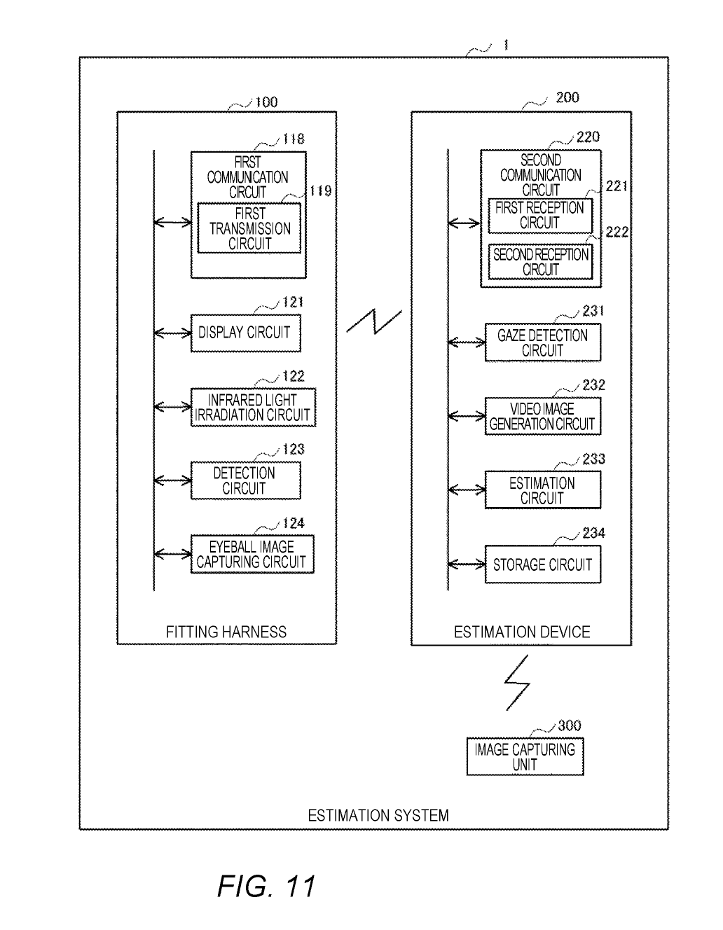

(2) In the embodiment described above, as the technique for the estimation device specifying the position of the fitting harness within the predetermined space, the processor of the estimation device executes the estimation program or the like for the estimation. However, this may be realized by a logic circuit (hardware) or a dedicated circuit formed in an integrated circuit (IC) chip, a large scale integration (LSI), or the like in the device. In addition, these circuits may be realized by one or a plurality of integrated circuits. The functions of a plurality of function units described in the embodiment described above may be realized by one integrated circuit. The LSI is sometimes referred to as VLSI, super LSI, ultra LSI, or the like depending on the difference in the degree of integration. That is, as illustrated in FIG. 11, the estimation device 200 may be constituted of a first communication circuit 221, a gaze detection circuit 231, a video image generation circuit 232, an estimation circuit 233, and a storage circuit 234. The functions are similar to those of members having similar names described in the embodiment described above.

In addition, the estimation program may be recorded in the storage medium which can be read by the processor. As the storage medium, a “non-temporary tangible medium”, for example, a tape, a disk, a card, a semiconductor memory, a programmable logic circuit, or the like can be used. In addition, the estimation program may be supplied to the processor via an arbitrary transmission medium (communication network, broadcast waves, or the like) which can transmit the estimation program. The present invention can also be realized in a form of data signals embedded in carrier waves, in which the estimation program is realized through electronic transmission.

For example, the estimation program can be installed using script languages such as ActionScript and JavaScript (registered trademark), object-oriented programming languages such as Objective-C and Java (registered trademark), and Markup language such as HTML5.

(3) The configurations described in the embodiment described above and each of the supplementations may be suitably combined.

1. An estimation system comprising:
a fitting harness which a user wears and in which the user watches a video image;
an estimation device which estimates a position and a posture of the fitting harness within a predetermined space; and
an image capturing unit which captures an image of the predetermined space,
wherein the fitting harness includes
a plurality of marks which are provided on an external surface,
a detection unit which sequentially detects posture information indicating the posture of the fitting harness, and
a first transmission unit which sequentially transmits the posture information to the estimation device, and
wherein the estimation device includes
a storage unit which stores preset posture data of a case in which the fitting harness is present in each of a plurality of regions different from each other included in the predetermined space, for each of the regions,
a first reception unit which receives the posture information,
a second reception unit which receives a captured image from the image capturing unit, and
an estimation unit which estimates a region having a possibility that the fitting harness is present among the plurality of regions using the captured image and the preset posture data, and estimates the region by narrowing the preset posture data to be used for a second captured image from the position and the posture in a first captured image based on posture information received after the first captured image is received, when the position and the posture of the fitting harness are estimated based on the second captured image following the first captured image among the sequentially transmitted captured images.

2. The estimation system according to claim 1,
wherein a unique identifier is allocated to each of the plurality of marks, and
wherein the estimation unit estimates a position and a posture of the fitting harness by estimating which one of the unique identifiers corresponds to the mark of the fitting harness included in the captured image.

3. The estimation system according to claim 1 or 2,
wherein the posture information includes information indicating directions from a basic position with respect to three axes, and information indicating a state of rotation with respect to each of the axes.

4. The estimation system according to claim 1,
wherein the estimation unit further specifies a direction of a normal vector set for each of the marks and estimates the position and the posture of the fitting harness based on the specified normal vector.

5. The estimation system according to claim 1,
wherein the plurality of marks are LEDs.

6. The estimation system according to claim 1, further comprising:
a video image transmission device which generates a video image to be displayed in the fitting harness, based on the position and the posture of the fitting harness in the predetermined space estimated by the estimation unit, and transmits the video image.

7. The estimation system according to claim 1,
wherein the storage unit further stores a plurality of pieces of received posture information, and
wherein the estimation unit performs estimation using the posture information stored in the storage unit when estimation of the region is unable to be executed.

8. The estimation system according to claim 1,
wherein the preset posture data is information in which information for specifying a range included in the predetermined space, and information for calculating presence probability for determining whether or not the fitting harness is included in the range are mapped to each other.

9. An estimation method of estimating a position and a posture of a fitting harness, which includes a plurality of marks, which a user wears, and in which the user watches a video image, within a predetermined space, the estimation method comprising:
a storing step of storing preset posture data of a case in which the fitting harness is present in each of a plurality of regions different from each other included in the predetermined space, for each of the regions;
a first receiving step of receiving a captured image of the predetermined space in which the fitting harness is included;
a second receiving step of receiving posture information indicating the posture of the fitting harness from the fitting harness; and
an estimating step of estimating a region having a possibility that the fitting harness is present among the plurality of regions using the captured image and the preset posture data, and estimating the region by narrowing the preset posture data to be used for a second captured image from the position and the posture in a first captured image based on posture information received after the first captured image is received, when the position and the posture of the fitting harness are estimated based on the second captured image following the first captured image among the sequentially transmitted captured images.

10. An estimation program for causing a computer to estimate a position and a posture of a fitting harness, which includes a plurality of marks, which a user wears, and in which the user watches a video image, within a predetermined space, the estimation program realizing:
a storing function of storing preset posture data of a case in which the fitting harness is present in each of a plurality of regions different from each other included in the predetermined space, for each of the regions;
a first receiving function of receiving a captured image of the predetermined space in which the fitting harness is included;
a second receiving function of receiving posture information indicating the posture of the fitting harness from the fitting harness; and
an estimating function of estimating a region having a possibility that the fitting harness is present among the plurality of regions using the captured image and the preset posture data, and estimating the region by narrowing the preset posture data to be used for a second captured image from the position and the posture in a first captured image based on posture information received after the first captured image is received, when the position and the posture of the fitting harness are estimated based on the second captured image following the first captured image among the sequentially transmitted captured images.
